(19) United States
(12) Patent Application Publication
(10) Pub. No.: US 2009/0302516 A1
(43) Pub. Date: Dec. 10, 2009

(54) SYSTEM, METHOD AND APPARATUS FOR CONTROL SURFACE WITH DYNAMIC COMPENSATION

(75) Inventor: Jean P. Steele, Southlake, TX (US)

Correspondence Address: BRACEWELL & GIULIANI LLP, P.O. BOX 61389, HOUSTON, TX, 77208-1389, US

(73) Assignee: LOCKHEED MARTIN CORPORATION, Bethesda, MD (US)

(21) Appl. No.: 12/133,822

(22) Filed: Jun. 5, 2008

(51) Int. Cl. F16F 9/53; F16F 15/03

(52) U.S. Cl. 267/140.15; 701/3

(57) ABSTRACT

An aircraft flight control surface has an actuator that employs a magneto-rheological (MR) fluid for dynamically adjusting the responsiveness of the control surface. The MR fluid may be used as a primary or secondary control in the event that a primary control actuator fails. In the event of system failures associated with the primary control, an alternate level of performance may be provided by the secondary control and communicated to the overall flight control system. This permits the control surface actuator to reactively and proactively respond to changes associated with the flight control system. If the design fails, it also permits a safe mode of operation should the ability to dynamically adjust the viscosity of the MR fluid be negatively impacted. The safe mode of operation may involve a reduced level of performance.

### BACKGROUND OF THE INVENTION

1. Technical Field

The present invention relates in general to dynamic manipulation of control surfaces and, in particular, to an improved system, method and apparatus for an aircraft flight control surface having a dynamic compensation capacity for both reactively and proactively manipulating the control surface.

2. Description of the Related Art

In the prior art, the control surfaces of aircraft (e.g., rudders, ailerons, etc.; sometimes referred to as “flaps”) are manipulated by mechanical actuators that selectively move the control surfaces in response to the overall flight control system of the aircraft. The size of the actuator typically is determined by stiffness requirements of the control surface. The stiffness requirements for structural dynamics usually require the size of the actuator to be greater than what is required for maneuver design load capacity.

In the event of actuator failure, there also is a redundancy requirement for control surface actuators so that the control surface can still be operated as a moveable flight control surface (i.e., it must be fail safe). This requirement makes the size of the actuator and its mechanical complexity significantly greater than what is required for non-redundant maneuver design load capacity. Historically, these design criteria have been addressed by adding power overcapacity and extra design complexity within the actuator. Although those solutions are workable, an improved aircraft flight control surface actuator that overcomes the limitations of previous designs would be desirable.

### SUMMARY OF THE INVENTION

Embodiments of a system, method, and apparatus for active manipulation of the stiffness of a control surface and a control surface actuator are disclosed. The manipulation may be accomplished both proactively and reactively. The control surface is coupled to one or more sensors and actuators so that the actuators can respond to sensed conditions. The control surface is further coupled to an overall flight control system of the aircraft so that the actuator can respond proactively to planned or anticipated maneuvers of the control surface. The invention does not replace the actuator but assists and enables it to meet selected design requirements. The invention allows actuator power capacity to be reduced to match maneuver force requirements, rather than being designed for stiffness. The invention also alleviates complexity within the actuator design.

By reducing the moveable control surface actuator's power capacity, the weight and size requirements of the actuator are reduced. The entire control surface actuator system may have more complexity due to the addition of the invention, however, the reduction in actuator weight and complexity offsets the additions to the overall system. The device may be used to provide stiffness similar to a hydraulically pressurized actuator, but the device is easier to use, modify and service (e.g., remove and replace) because it is a sealed unit and has no plumbing connections. As an added benefit, the device and the actuator may be complementary for automated built-in-testing (BIT) of each other for proper operation prior to each flight of the aircraft.

In some embodiments, the invention uses an active mechanical damping device that incorporates magneto-rheological (MR) technology. The device has a valve through which an MR fluid is selectively manipulated based on the properties of the fluid. A magnetic field is applied and limited to only the area of the valve orifice through which the MR fluid flows. The magnetic field, which is adjustable, variably changes the local flow rate of the fluid through the orifice which, in turn, regulates the motion of the control surface. Thus, the invention is active with regard to the damping effect, but is passive with regard to its power consumption to move the control surfaces being manipulated. The device provides a control surface and structure stiffening effect at frequencies that are critical for structural dynamics stiffness requirements. The device also acts as a back-up system to the actuator in the event of actuator failure, by facilitating a fail-safe operation, thereby reducing complexity of the actuator redundant design.

The foregoing and other objects and advantages of the present invention will be apparent to those skilled in the art, in view of the following detailed description of the present invention, taken in conjunction with the appended claims and the accompanying drawings.

### BRIEF DESCRIPTION OF THE DRAWINGS

So that the manner in which the features and advantages of the present invention are attained and can be understood in more detail, a more particular description of the invention briefly summarized above may be had by reference to the embodiments thereof that are illustrated in the appended drawings. However, the drawings illustrate only some embodiments of the invention and therefore are not to be considered limiting of its scope as the invention may admit to other equally effective embodiments.

FIGS. 1-3 are schematic sectional views of embodiments of a flight control surface manipulation system for an aircraft constructed in accordance with the invention, and illustrate various positions that may be used during operation of the aircraft; and

FIG. 4 is an isometric view of one embodiment of a portion of a flight control surface manipulation system and is constructed in accordance with the invention.

### DETAILED DESCRIPTION OF THE INVENTION

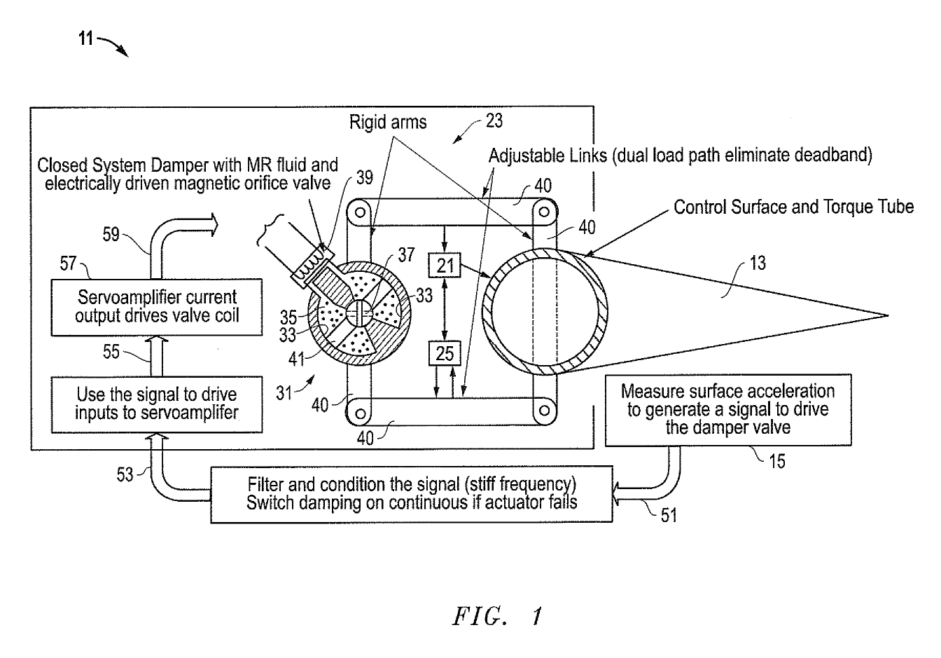

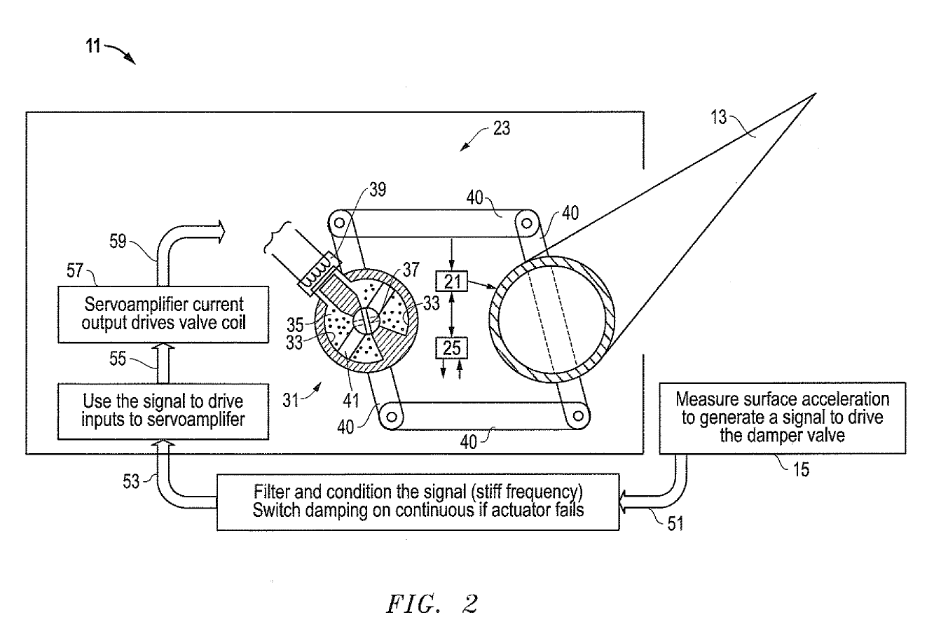

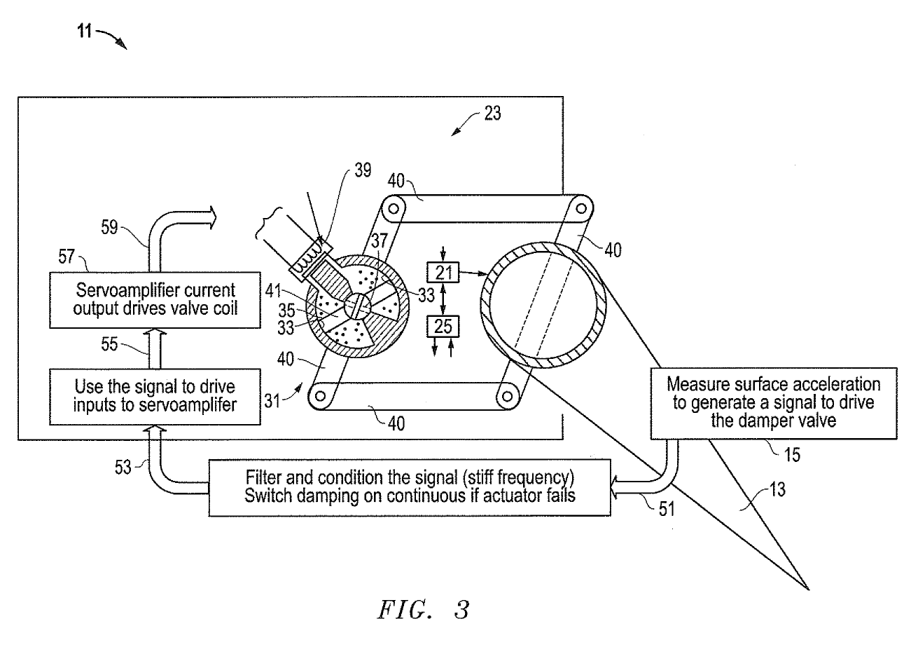

Referring to FIGS. 1-4, embodiments of a system, method and apparatus for an aircraft flight control surface having a dynamic compensation capacity for both reactively and proactively manipulating the control surface. The invention is well suited for controlling and manipulating a flight control device or “flap” of an aircraft, such as a rudder, an aileron, an elevator, etc., as is known in the art.

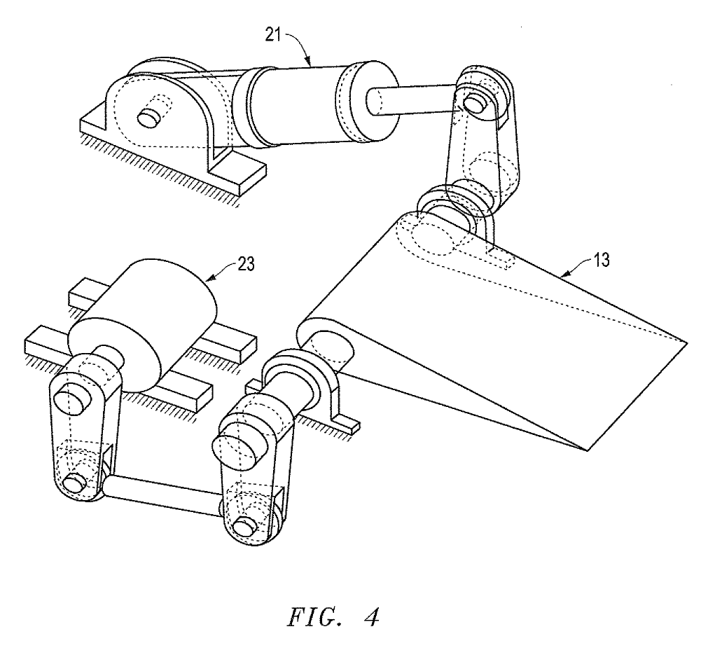

The aircraft is schematically indicated in FIG. 1 as having a body 11 with wings and tail components. A flight control device or flap 13 is movably mounted to the body 11 for adjusting flight of the aircraft during operation. A sensor 15 is mounted to the body 11 for detecting a movement (e.g., acceleration) of the flap 13 as it is operated. The flap 13 may be controlled with a single manipulation device 21 or a plurality of manipulation devices 21, 23 (see, e.g., FIG. 4) for redundancy and additional safety. For example, a “primary” manipulation device 21 may used for primarily manipulating the flap 13 during operation of the aircraft, which would encompass all routine operations of the flap. A secondary manipulation device 23 may be coupled to the flap 13 and to the primary manipulation device 21 for the reasons described herein. However, the secondary manipulation device 23 may comprise the only means of controlling the flap 13.

In one embodiment, the secondary manipulation device 23 is responsive to the sensor 15 for manipulating the flap 13 when inadequate manipulation of the flap 13 is provided by the primary manipulation device 21. The secondary manipulation device 23 may be used to act as a damper for selectively damping motion of the flap 13 during flight of the aircraft.

The invention may further comprise an overall aircraft flight control system 25. The primary and secondary manipulation devices 21, 23 may be coupled to the aircraft flight control system 25 for responding proactively to planned maneuvers of the flap 13. The primary and secondary manipulation devices 21, 23 also may be used to match maneuver force requirements of the flap 13 during flight.

In one embodiment, the secondary manipulation device 23 comprises an actuator 31 having chambers 33 with a magneto-rheological (MR) fluid 35. In an alternate embodiment, the fluid may comprise a siliconized fluid. A valve 37 extends between the chambers 33 so that the MR fluid 35 may pass between the chambers 33. A magnetic field generator 39 is used to generate a magnetic field that selectively and dynamically manipulates a property of the MR fluid 35 as it passes through the valve 37 to adjust a stiffness and responsiveness of the flap 13. As illustrated, the flap 13 is mechanically linked with linkages 40 to a piston 41 that pushes the MR fluid 35 between chambers 33. In one embodiment, the secondary manipulation device 23 is a sealed unit and has no plumbing connections, and a stiffness of the flap 13 is controlled at frequencies that are critical for structural dynamics.

In the embodiment shown, only a portion of the MR fluid 35 is manipulated locally at and adjacent to the valve 37, rather than an entire volume of the MR fluid 35. The property of the MR fluid that is manipulated may be viscosity, and the viscosity is variable and responsive to the magnetic field for providing a range of active and passive mechanical damping for the flap 13. In one embodiment, the MR fluid and magnetic field fail to a safe mode if an ability to control viscosity fails.

As described herein, the sensor 15 measures acceleration of the flap 13 to generate a signal 51 to drive damping motion of the secondary manipulation device 23. The invention may further comprise filtering and conditioning 53 the signal, using the filtered and conditioned signal 53 to drive inputs 55, and receiving the inputs 55 with a servo amplifier 57 to produce current output 59 to drive a valve coil in the generator 39 in the secondary manipulation device 23 to manipulate the MR fluid 35.

The invention has numerous advantages. The MR fluid dynamically adjusts the responsiveness of the control surface. The MR fluid may be used as a secondary control in the event that the primary control actuator for the control surface fails. The invention further provides a degraded level of performance that may be communicated to the overall flight control system. This design permits the control surface actuator to reactively and proactively respond to changes associated with the flight control system. Failure of the MR fluid system further permits a safe mode of operation should the ability to dynamically adjust the viscosity of the MR fluid be negatively impacted. The safe mode of operation may involve a reduced level of performance.

While the invention has been shown or described in only some of its forms, it should be apparent to those skilled in the art that it is not so limited, but is susceptible to various changes without departing from the scope of the invention.

What is claimed is:

1. A system for controlling and manipulating a flight control device on an aircraft, comprising:
an aircraft having a body;
a flight control device movably mounted to the body for adjusting flight of the aircraft;
a sensor mounted to the body for detecting a movement of the flight control device;
a primary manipulation device for primarily manipulating the flight control device during operation of the aircraft; and
a secondary manipulation device coupled to the flight control device and the primary manipulation device, the secondary manipulation device being responsive to the sensor for manipulating the flight control device when inadequate manipulation of the flight control device is provided by the primary manipulation device, and the secondary manipulation device acting as a damper for selectively damping motion of the flight control device during flight of the aircraft.

2. A system according to claim 1, wherein the flight control device is selected from the group consisting of a rudder, an aileron, and an elevator.

3. A system according to claim 1, further comprising an aircraft flight control system, wherein the secondary manipulation device is coupled to the aircraft flight control system for responding proactively to planned maneuvers of the flight control device.

4. A system according to claim 1, wherein the secondary manipulation device is used to match maneuver force requirements of the flight control device.

5. A system according to claim 1, wherein the secondary manipulation device comprises an actuator having chambers with a magneto-rheological (MR) fluid, a valve through which the MR fluid passes between the chambers, and a magnetic field generator for generating a magnetic field that selectively and dynamically manipulates a property of the MR fluid as it passes through the valve to adjust a stiffness and responsiveness of the flight control device.

6. A system according to claim 5, wherein the secondary manipulation device is a sealed unit and has no plumbing connections, and a stiffness of the flight control device is controlled at frequencies that are critical for structural dynamics.

7. A system according to claim 5, wherein only a portion of the MR fluid is manipulated locally at and adjacent to the valve, rather than an entire volume of the MR fluid.

8. A system according to claim 5, wherein the property of the MR fluid is viscosity, and is variable and responsive to the magnetic field for providing a range of active and passive mechanical damping.

9. A system according to claim 8, wherein the MR fluid and magnetic field fail to a safe mode if an ability to control viscosity fails.

10. A system according to claim 1, wherein the secondary manipulation device comprises an actuator having chambers with a siliconized fluid, a valve through which the siliconized fluid passes between the chambers to provide active mechanical damping of the flight control device.

11. A system according to claim 1, wherein the sensor measures acceleration of the flight control device to generate a signal to drive damping motion of the secondary manipulation device.

12. A system according to claim 11, further comprising:
filtering and conditioning the signal;
using the filtered and conditioned signal to drive inputs; and
receiving the inputs with a servo amplifier to produce current output to drive a valve coil in the secondary manipulation device.

13. A system for controlling and manipulating a flap on an aircraft, comprising:
an aircraft having a body;
a flap movably mounted to the body for adjusting flight of the aircraft;
a sensor mounted to the body for detecting an acceleration of the flap;
a flap manipulation device coupled to the flap for manipulating the flap during operation of the aircraft, the flap manipulation device also being responsive to the sensor for manipulating the flap and selectively damping motion of the flap during flight of the aircraft; and
the flap manipulation device having an actuator having chambers with a magneto-rheological (MR) fluid, a valve through which the MR fluid passes between the chambers, and a magnetic field generator for generating a magnetic field that selectively and dynamically manipulates a property of the MR fluid as it passes through the valve to adjust a stiffness and responsiveness of the flap.

14. A system according to claim 13, wherein the flap is selected from the group consisting of a rudder, an aileron, and an elevator.

15. A system according to claim 13, further comprising an aircraft flight control system, wherein the flap manipulation device is coupled to the aircraft flight control system for responding proactively to planned maneuvers of the flap.

16. A system according to claim 13, wherein the flap manipulation device is used to match maneuver force requirements of the flap.

17. A system according to claim 13, wherein the flap manipulation device is a sealed unit and has no plumbing connections, and a stiffness of the flap is controlled at frequencies that are critical for structural dynamics.

18. A system according to claim 13, wherein only a portion of the MR fluid is manipulated locally at and adjacent to the valve, rather than an entire volume of the MR fluid.

19. A system according to claim 13, wherein the property of the MR fluid is viscosity, and is variable and responsive to the magnetic field for providing a range of active and passive mechanical damping for the flap.

20. A system according to claim 19, wherein the MR fluid and magnetic field fail to a safe mode if an ability to control viscosity fails.

21. A system according to claim 13, wherein the sensor measures acceleration of the flap to generate a signal to drive damping motion of the flap manipulation device.

22. A system according to claim 21, further comprising:
filtering and conditioning the signal;
using the filtered and conditioned signal to drive inputs; and
receiving the inputs with a servo amplifier to produce current output to drive a valve coil in the flap manipulation device to manipulate the MR fluid.
